(19) United States
(12) Patent Application Publication
(10) Pub. No.: US 2015/0271075 A1
(43) Pub. Date: Sep. 24, 2015

(54) Switch-based Load Balancer

(71) Applicant: Microsoft Corporation, Redmond, WA (US)

(72) Inventors: Ming Zhang, Redmond, WA (US); Rohan Gandhi, West Lafayette, IN (US); Lihua Yuan, Redmond, WA (US); David A. Maltz, Bellevue, WA (US); Chuanxiong Guo, Bellevue, WA (US); Haitao Wu, Redmond, WA (US)

(73) Assignee: Microsoft Corporation, Redmond, WA (US)

(21) Appl. No.: 14/221,056

(22) Filed: Mar. 20, 2014

(51) Int. Cl. H04L 12/803; H04L 12/743; H04L 12/46; H04L 12/741

(52) U.S. Cl. CPC H04L 47/125; H04L 45/745; H04L 45/7453; H04L 12/4633

(57) ABSTRACT

A load balancer system is described herein which uses one or more switch-based hardware multiplexers, each of which performs a multiplexing function. Each such hardware multiplexer operates based on an instance of mapping information associated with a set of virtual IP (VIP) addresses, corresponding to a complete set of VIP addresses or a portion of the complete set. That is, each hardware multiplexer operates by mapping VIP addresses that correspond to its set of VIP addresses to appropriate direct IP (DIP) addresses. In another implementation, the load balancer system may also use one or more software multiplexers that perform a multiplexing function with respect to the complete set of VIP addresses. A main controller can generate one or more instances of mapping information, and then load the instance(s) of mapping information on the hardware multiplexer(s), and the software multiplexer(s) (if used).

### BACKGROUND

A data center commonly hosts a service using plural processing resources, such as servers. The plural processing resources implement redundant instances of the service. The data center employs a load balancer system to evenly spread the traffic directed to a service (which is specified using a particular virtual IP address) among the set of processing resources that implement the service (each of which is associated with a direct IP address).

The performance of the load balancer system is of prime importance, as the load balancer system plays a role in most of the traffic that flows through the data center. In a traditional load balancing solution, a data center may use plural special-purpose middleware units that are configured to perform a load balancing function. More recently, data centers have used only commodity servers to perform load balancing tasks, e.g., using software-driven multiplexers that run on the servers. These solutions, however, may have respective drawbacks.

### SUMMARY

A load balancer system is described herein which, according to one implementation, repurposes one or more hardware switches in a data processing environment as hardware multiplexers, for use in performing a load balancing operation. If a single switch-based hardware multiplexer is used, that multiplexer may store an instance of mapping information that represents a complete set of virtual IP (VIP) addresses that are handled by the data processing environment. If two or more switch-based hardware multiplexers are used, the different hardware multiplexers may store different instances of mapping information, respectively corresponding to different portions of the complete set of VIP addresses.

In operation, the load balancer system directs an original packet associated with a particular VIP address to a hardware multiplexer to which that VIP address has been assigned. The hardware multiplexer uses its instance of mapping information to map the particular VIP address to a particular direct IP (DIP) address, potentially selected from a set of possible DIP addresses. The hardware multiplexer then encapsulates the original packet in a new packet that is addressed to the particular DIP address, and sends the new packet to a resource (e.g., a server) associated with the particular DIP address.

According to another illustrative aspect, a main controller can generate the one or more instances of mapping information on an event-driven and/or periodic basis. The main controller can then forward the instance(s) of mapping information to the hardware multiplexer(s), where that information is loaded into the table data structures of the hardware multiplexer(s).

According to another illustrative aspect, the main controller can also send a complete instance of mapping information (representing the complete set of VIP addresses) to one or more software multiplexers, e.g., as implemented by one or more servers. In some scenarios, the load balancer system may use the software multiplexers in a backup or support-related role, while still relying on the hardware multiplexer(s) to handle the bulk of the packet traffic in the data processing environment.

The above-summarized load balancer system may offer various advantages. For example, the load balancer system can leverage the unused functionality provided by pre-existing switches in the network to provide a low cost load balancing solution. Further, the load balancer system can offer organic scalability in the sense that additional hardware switches can be repurposed to provide a load balancing function when needed. Further, the load balancer system offers satisfactory latency by virtue of its predominant use of hardware devices to perform load balancing tasks. The load balancer system also offers satisfactory availability (e.g., resilience to failure) and flexibility—in part, through its use of software multiplexers.

In addition, or alternatively, other implementations of the load balancer system may repurpose one or more other hardware units within a data processing environment to serve as one or more hardware multiplexers. In addition, or alternatively, other implementations of the load balancer system may use one or more specially configured units to serve as one or more hardware multiplexers.

The above approach can be manifested in various types of systems, devices, components, methods, computer readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a data processing environment that uses a first implementation of a load balancer system. The load balancer system, in turn, uses one or more hardware switches as hardware multiplexers.

FIG. 2 represents a mapping operation performed by one particular hardware multiplexer within the load balancer system of FIG. 1.

FIG. 3 represents one particular implementation of the data processing environment of FIG. 1.

FIG. 4 shows one implementation of a switch-based hardware multiplexer, for use in the load balancer system of FIG. 1.

FIG. 5 shows one table data structure that can be used to provide mapping information, within the hardware multiplexer of FIG. 4.

FIG. 6 shows functionality that may be provided by a resource (such as a server) associated with a particular direct IP (DIP) address, within the data processing environment of FIG. 1. That resource includes host agent logic.

FIG. 7 shows one implementation of a main controller, which is a component within the load balancer system of FIG. 1.

FIG. 8 shows another data processing environment that employs a second implementation of a load balancer system. That load balancer system makes uses of a combination of one or more switch-based hardware multiplexers and one or more software multiplexers.

FIG. 9 shows one implementation of the data processing environment of FIG. 8.

FIG. 10 shows one implementation of a software multiplexer, used by the load balancer system of FIG. 8.

FIG. 11 shows functionality for mapping a virtual IP (VIP) address to a host IP (HIP) address associated with a host computing device, and then, at the host computing device, mapping the HIP address to a particular virtual machine instance running on the host computing device.

FIG. 12 shows the use of a hierarchy of hardware multiplexers to map a set of VIP addresses to a large set of DIP addresses, where portions of the set of DIP addresses are allocated to respective child-level hardware multiplexers.

FIG. 13 is a procedure that explains one manner of operation of the load balancer systems of FIGS. 1 and 8.

FIG. 14 is a procedure that explains one manner of operation of an individual hardware multiplexer.

FIG. 15 is a procedure which represents an overview of an assignment operation performed by the main controller of FIG. 7.

FIGS. 16 and 17 together show a procedure that provides additional details of the assignment operation of FIG. 15, according to one implementation.

FIG. 18 shows illustrative computing functionality that can be used to implement various aspects of some of the features shown in the foregoing drawings.

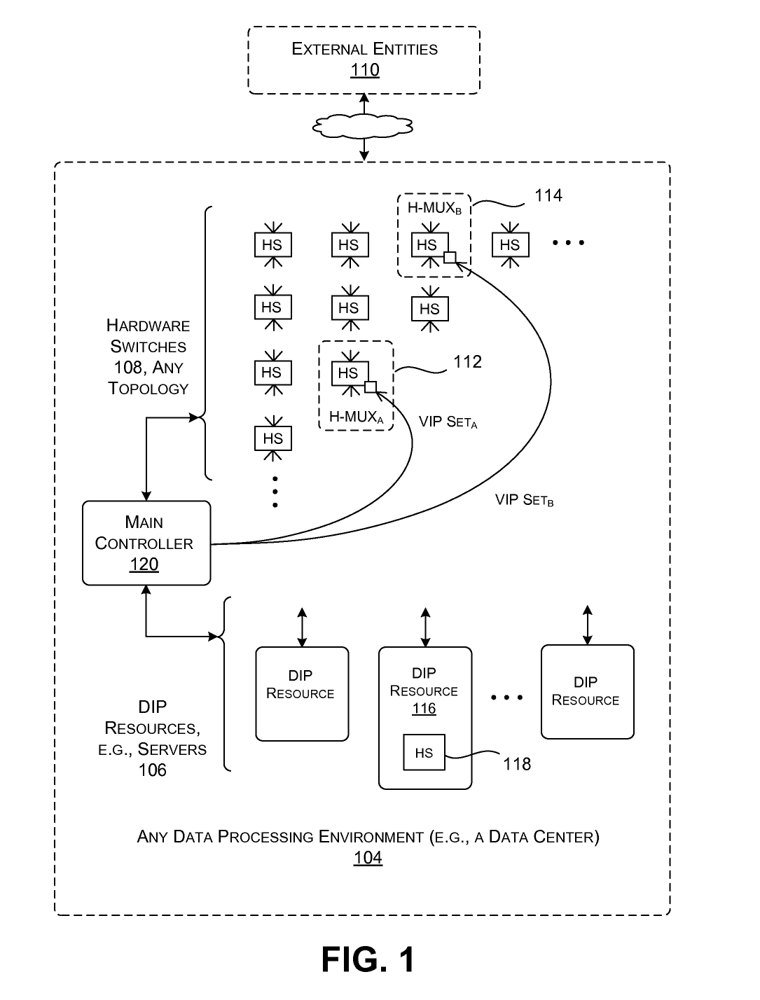

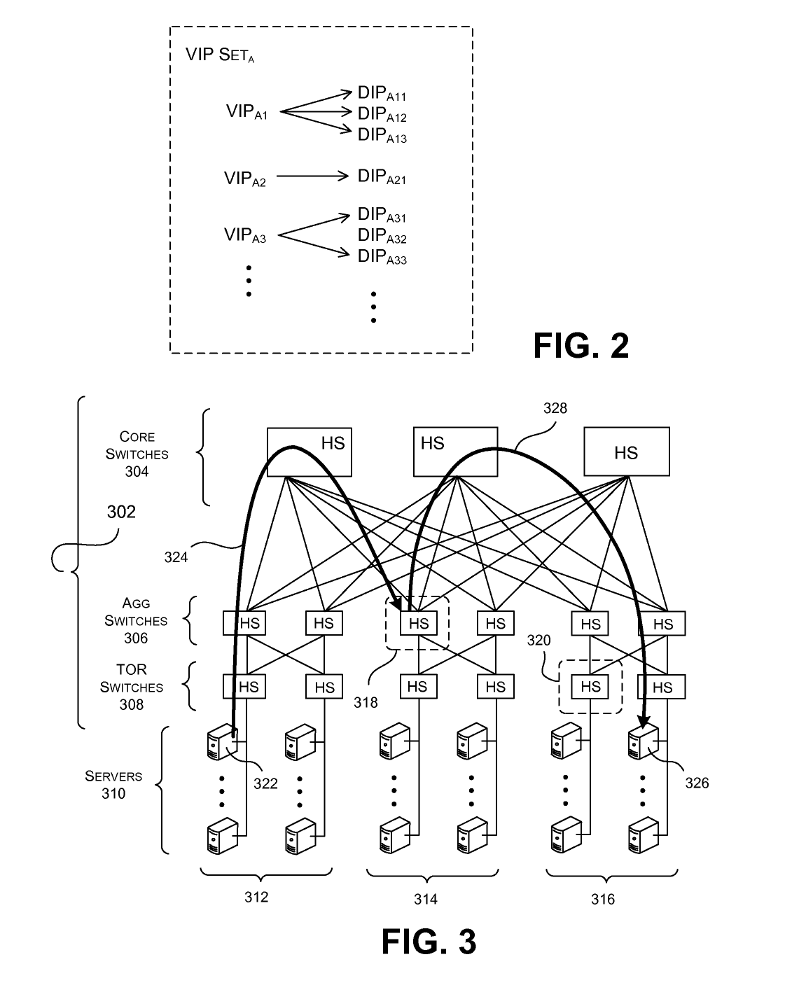

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative load balancer system for balancing traffic within a data processing environment, such as a data center. Section B sets forth illustrative methods which explain the operation of the mechanisms of Section A. Section C describes illustrative computing functionality that can be used to implement various aspects of the features described in the preceding sections.

As a preliminary matter, some of the figures describe concepts in the context of one or more structural components. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software running on computer equipment, hardware (e.g., chip-implemented logic functionality), etc., and/or any combination thereof.

As to terminology, the phrase “configured to” encompasses any way that any kind of physical and tangible functionality can be constructed to perform an identified operation. The functionality can be configured to perform an operation using, for instance, software running on computer equipment, hardware (e.g., chip-implemented logic functionality), etc., and/or any combination thereof.

The term “logic” encompasses any physical and tangible functionality for performing a task. For instance, each operation illustrated in the flowcharts corresponds to a logic component for performing that operation. An operation can be performed using, for instance, software running on computer equipment, hardware (e.g., chip-implemented logic functionality), etc., and/or any combination thereof. When implemented by computing equipment, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not expressly identified in the text. Further, any description of a single entity is not intended to preclude the use of plural such entities; similarity, a description of plural entities is not intended to preclude the use of a single entity. Finally, the terms “exemplary” or “illustrative” refer to one implementation among potentially many implementations.

A. Mechanisms for Implementing a Switch-Based Load Balancer

A.1. Overview of a First Implementation of the Load Balancer

FIG. 1 shows a data processing environment 104 that uses a first implementation of a load balancer system. The data processing environment 104 may correspond to any framework in which data-bearing traffic is routed to and from resources 106 which implement one or more services. For example, the data processing environment may correspond to a data center, an enterprise system, etc.

Each resource in the data processing environment 104 is associated with a direct IP (DIP) address, and is therefore henceforth referred to as a DIP resource. In one implementation, the DIP resources 106 correspond to a plurality of servers. In another implementation, each server may host one or more functional modules or component hardware resources; each such module or component resource may constitute a DIP resource associated with an individual DIP address.

The data processing environment 104 also includes a collection of hardware switches 108, individually denoted in FIG. 1 as boxes bearing the label “HS.” The term hardware switch is to be construed generally herein; it refers to any component, implemented primarily in hardware, which performs a packet-routing operation, or may be configured to perform a packet-routing function. In connection therewith, each hardware switch may perform one or more native component functions, such as traffic splitting (e.g., to support Equal Cost Multipath (ECMP) routing), encapsulation (to support tunneling), and so on

In the context of FIG. 1, each individual switch is coupled to one or more other switches and/or one or more DIP resources 106 and/or one or more other entities. Collectively, therefore, the hardware switches 108 and the DIP resources 106 form a network having any topology. The data processing environment 104 and the network that it forms are treated as interchangeable terms herein. In operation, the network provides routing functionality by which external entities 110 may send packets to DIP resources 106. The external entities may correspond to user devices, other services hosted by other data centers, etc. Further, the routing framework allows any service within the data processing environment 104 to send packets to any other service within the same data processing environment 104.

The function of the load balancer system is to evenly distribute packets that are directed to a particular service among the DIP resources that implement that service. More specifically, an external or internal entity may make reference to a service that is hosted by the data processing environment 104 using a particular virtual IP (VIP) address. That particular VIP address is associated with a set of DIP addresses, corresponding to respective DIP resources. The load balancer system performs a multiplexing function which entails evenly mapping packets directed to the particular VIP address among the DIP addresses associated with that VIP address.

The load balancer system includes a subset of the hardware switches 108 that have been repurposed to perform the above-described multiplexing function. In this context, each such hardware switch is referred to herein as a hardware multiplexer, or H-Mux for brevity. In one case, the subset of hardware switches 108 that is chosen to perform a multiplexing function includes a single hardware switch. In another case, the subset includes two or more switches. FIG. 1, for instance, shows a case in which the subset includes two representative hardware multiplexers, namely H-Mux_{A} 112 and H-Mux_{B} 114. And in some scenarios, the load balancer system may allocate many more hardware switches for performing a multiplexing function.

More specifically, any hardware switch in the data processing environment 104 may be chosen to perform a multiplexing function, regardless of its position and function within the network of interconnected hardware switches 108. For example, a common data center environment includes core switches, aggregation switches, top-of-rack (TOR) switches, etc., any of which can be repurposed to perform a multiplexing function. In addition, or alternatively, any DIP resource (such as DIP resource 116) may include a hardware switch (such as a hardware switch 118) that can be repurposed to perform a multiplexing function.

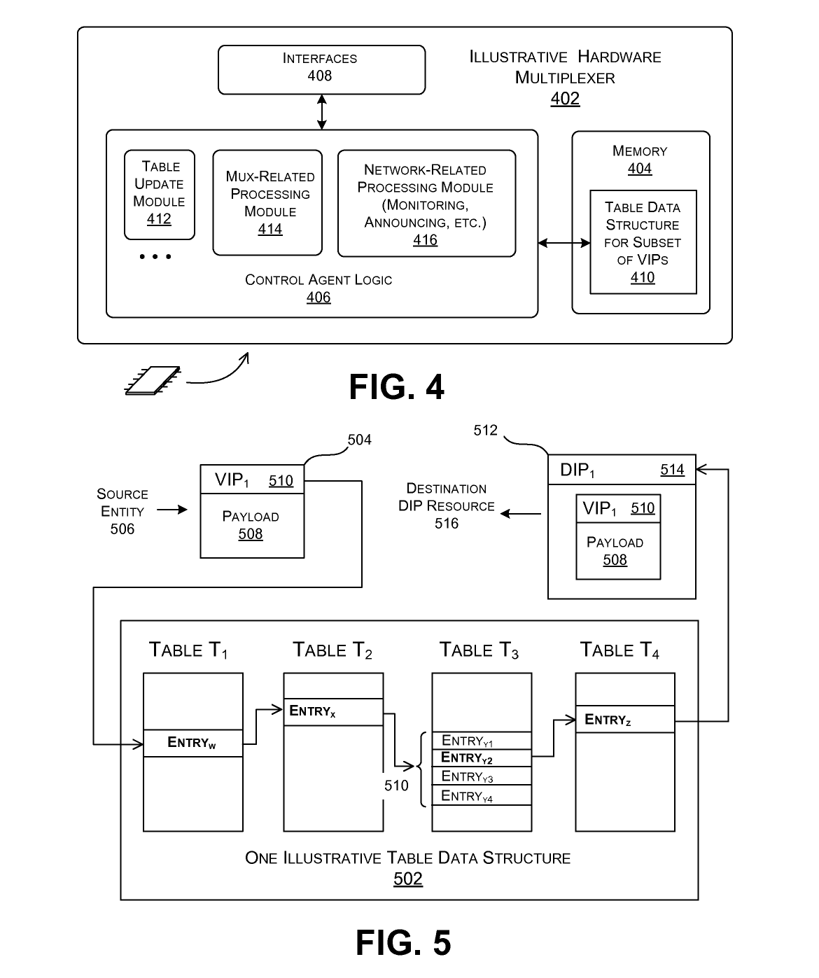

A hardware switch may be repurposed to perform a multiplexing function by connecting together two or more tables provided by the hardware switch to form a table data structure. The load balancer system can then load particular mapping information into the table data structure; the mapping information constitutes a collection of entries loaded into appropriate slots provided by the tables. Control agent logic then leverages the table data structure to perform a multiplexing function, as will be explained more fully in context of FIGS. 4 and 5 (below).

Consider the implementation in which the load balancing system uses a single hardware switch to perform a multiplexing function, to provide a single multiplexer. That single hardware multiplexer stores mapping information that corresponds to a full set of VIP addresses handled by the data processing environment 104. The hardware multiplexer can then use any route announcement strategy, such as Border Gateway Protocol (BFP), to notify all entities within the data processing environment 104 of the fact that it handles the complete set of VIP addresses.

Each hardware switch, however, may have limited memory capacity. In some implementations, therefore, a single hardware switch may be unable to store mapping information associated with the full set of VIP addresses handled by the data processing environment 104—particularly in the case of large data centers which handle a large number of services and corresponding VIP addresses. Furthermore, imposing a large multiplexing task on a particular hardware switch may exceed the capacities of other resources of the data processing environment 104, such as other hardware switches, links that connect the switches together, and so on. To address this issue, in some implementations, the load balancer system intelligently assigns particular multiplexing tasks to particular hardware switches in the network, so as to not exceed the capacity of any resource in the network.

More specifically, in some implementations, the load balancer system loads different instances of mapping information into different respective hardware multiplexers. Each such instance corresponds to a different set of VIP addresses, associated with a subset of a complete set of VIP addresses that are handled by the data processing environment 104. For example, the load balancing functionality may load a first instance of mapping information into the H-Mux_{A} 112, corresponding to a VIP set_{A}. The load balancing functionality may load a second instance of mapping information into the H-Mux_{B} 114, corresponding to VIP set_{B}. The VIP set_{A} corresponds to a different collection of VIP address compared to VIP set_{B}. The hardware multiplexers can then use BGP to notify all entities within the data processing environment 104 of the VIP addresses that have been assigned to the hardware multiplexers.

Although not shown in FIG. 1, the load balancer system may also store redundant copies of the same instance of mapping information on two or more hardware switches, such as by loading mapping information corresponding to VIP set_{A} on two or more hardware switches. The load balancer system can also store redundant copies of mapping information associated with a complete set of VIP addresses on two or more hardware switches. The load balancer system may provide redundant copies of VIP sets to improve the availability of the mapping information, associated with those sets, in the event of switch failure.

In operation, the data processing environment 104 routes any packet addressed to a particular VIP address to a hardware multiplexer which handles that VIP address. For example, assume that an external or internal entity sends a packet having a VIP address that is included in the VIP set_{A}. The data processing environment 104 forwards that packet to H-Mux_{A} 112. The H-Mux_{A} then proceeds to map the VIP address to a particular DIP address, and then uses IP-in-IP encapsulation to send the data packet to whatever DIP resource is associated with that DIP address.

A main controller 120 governs various aspects of the load balancer system. For example, the main controller 120 can generate one or more instances of mapping information on an event-driven basis (e.g., upon the failure of a component within the data processing environment 104) and/or on a periodic basis. More specifically, the main controller 120 intelligently selects: (a) which hardware switches are to be repurposed to serve a multiplexing task; and (b) which VIP addresses are to be allocated to each such hardware switch. The main controller 120 can then load the instances of mapping information onto the selected hardware switches. The load balancer system as a whole may be conceptualized as comprising the one or more of hardware multiplexers (implemented by respective hardware switches), together with the main controller 120.

The above description applies to the inbound path of a packet sent from a source entity to a target DIP resource. The data processing environment 104 can handle the return outbound path in various ways. For example, in one implementation, the data processing environment 104 can use a Direct Server Return (DSR) technique to send return packets to the source entity, bypassing the Mux functionality through which the inbound packet was received. The data processing environment 104 handles this task by using host agent logic in the DIP resource to preserve the address associated with the source entity. Additional information regarding the DSR technique can be found in commonly assigned U.S. Pat. No. 8,416,692, issued on Apr. 9, 2013, and naming the inventors of Parveen Patel, et al.

As a final point with respect to FIG. 1, the load balancer system can also repurpose other types of hardware units in the data processing environment 104 to perform a multiplexing function, which may not constitute switches per se. For example, the load balancer system can use one or more Network Interface Controller (NIC) units provided by DIP resources to function as one or more hardware multiplexers. Alternatively, or in addition, the load balancer system can include one or more specially-configured hardware units that perform a multiplexing function, e.g., not predicated on the reuse of existing hardware units within the data processing environment 104.

FIG. 2 represents a mapping operation performed by the H-Mux_{A} 112 of FIG. 1. The H-Mux_{A} 112 is associated with a set of VIP addresses, VIP Set_{A}, corresponding to VIP address VIP_{A1} to VIP_{An}. Each VIP address is associated with one or more DIP addresses, corresponding, respectively, to one or more DIP resources (e.g., servers). For example, VIP_{A1} is associated with DIP addresses DIP_{A11}, DIP_{A12}, and DIP_{A13}. These VIP addresses and DIP addresses are represented in high-level notation in FIG. 2 to facilitate explanation; in actuality, they may be formed as IP addresses. In the case of FIG. 2, the set of VIP addresses corresponds to a portion of a complete set of VIP addresses. But in another implementation, a single hardware switch may store mapping information associated with the complete set of VIP addresses.

FIG. 3 represents one particular implementation of the data processing environment 104 of FIG. 1. In this scenario, the hardware switches 302 include core switches 304, aggregation (agg) switches 306, and top-of-rack (TOR) switches 308. The DIP resources correspond to a collection of servers 310, arranged in a plurality of racks. The hardware switches 302 and the servers 310 collectively form a hierarchical routing network, e.g., having a “fat tree” topology. Further, the hardware switches 302 and the servers 310 may form a plurality of containers (312, 314, 316) along the “horizontal” dimension of the network.

In this particular example, the data processing environment of FIG. 3 includes two hardware multiplexers (318, 320). For example, the hardware multiplexer 318 corresponds to an aggregation switch that has been repurposed to provide a multiplexing function, in addition to its native packet-routing role in the network of switches 302. The hardware multiplexer 320 corresponds to a TOR switch that has been repurposed to perform a multiplexing function, in addition to its native packet-routing role in the network of switches 302. The hardware multiplexer 318 is associated with a first set of VIP addresses and the hardware multiplexer 320 is associated with a second set of VIP addresses, which differs from the first set. The hardware multiplexers (318, 320) can flood their VIP assignments to all other entities in the data processing environment using any protocol, such as BGP. Although not shown, in another case, the data processing environment can use a single hardware multiplexer that handles a complete set of VIP addresses.

Consider the illustrative scenario in which a server 322 seeks to send a packet to a particular service, represented by a VIP address. The packet that is sent therefore contains the VIP address in its header. Further assume that the particular VIP address of the packet belongs to the set of VIP addresses handled by the hardware multiplexer 318. In path 324, the routing functionality provided by the data processing environment routes the packet up through the network to a core switch, and then back down through the network to the hardware multiplexer 318 (where this path reflects the particular topology of the network shown in FIG. 3). The hardware multiplexer 318 then maps the VIP address to a particular DIP address, selected from a set of DIP addresses associated with the VIP address. Further, the hardware multiplexer 318 encapsulates the original data packet in a new packet, addressed to the particular DIP address. Assume that the chosen DIP address corresponds to a server 326. In a second path 328, the routing functionality routes the new packet up through the network to a core switch, and then back down through the network to the server 326.

The particular network topology and routing paths illustrated in FIG. 3 are cited by way of example, not limitation. Other implementations can use other network topologies and other strategies for routing information through the network topologies.

The load balancer system described in this section provides various potential benefits. First, the load balancer can offer satisfactory latency by virtue of its use of hardware functionality to perform multiplexing, as opposed to software functionality. Second, the load balancer system can be produced at low cost, since it repurposes existing switches already in the network, e.g., by leveraging the unused and idle resources of these switches. Third, the load balancer system can offer organic scalability, which means that additional multiplexing capability (to accommodate the introduction of additional VIP addresses) can be added to the load balancer system by repurposing additional existing hardware switches in the network. And as will be explained in greater detail in the following description, the load balancer system offers satisfactory availability and capacity.

By comparison, a traditional load-balancing solution that uses only special-purpose middleware units also offers satisfactory latency, but these units are typically expensive; their use therefore drives up the cost of the data center. A load-balancing solution that uses only software-driven multiplexers offers a flexible and scalable solution, but, because they run by executing software on general purpose computing devices, they offer non-ideal performance in terms of latency and throughput. The cost of purchasing multiple servers to perform software-driven multiplexing is also relatively high.

A.2. An Illustrative Hardware Switch

FIG. 4 shows one implementation of a hardware multiplexer 402, for use in the load balancer system of FIG. 1. In one implementation, the hardware multiplexer 402 is produced by repurposing a hardware switch of any type, and at any position within a network, to perform a multiplexing function. In another implementation, the hardware multiplexer 402 represents another type of hardware unit that has been repurposed to perform a multiplexing function. In another implementation, the hardware multiplexer 402 represents a custom-configured hardware unit for performing a multiplexing function. In any of these cases, the hardware multiplexer 402 may be implemented by an Application Specific Integrated Circuit (ASIC) of any type, or some other hardware-implemented logic component, such as a gate array, etc.

From a logical perspective, the hardware multiplexer 402 includes any type of storage resource, such as memory 404, together with any type of processing resource, such as control agent logic 406. The hardware multiplexer may interact with other entities via one or more interfaces 408. For example, the main controller 120 (of FIG. 1) may interact with the control agent logic 406 via one or more Application Programming Interfaces (APIs).

More specifically, the memory 404 stores a table data structure 410. As will be described in greater detail below, the table data structure 410 may be composed of one or more tables, populated with entries provided by the main controller 120. The populated table data structure 410 provides an instance of mapping information which maps VIP addresses to DIP addresses, for a particular set of VIP addresses, corresponding to either a complete set of VIP addresses associated with the data processing environment 104, or a portion of that complete set.

The control agent logic 406 includes plural components that perform different respective functions. For instance, a table update module 412 loads new entries into the table data structure 410, based on instructions from the main controller 120. A mux-related processing module 414 maps a particular VIP address to a particular DIP address using the mapping information provided by the table data structure 410, in a manner described in greater detail below. A network-related processing module 416 performs various network-related activities, such as sensing and reporting failures in neighboring switches, announcing assignments provided by the mapping information using BGP, and so on.

FIG. 5 shows one table structure 502 that can be used to provide mapping information, within the memory 404 of the hardware multiplexer 402 of FIG. 4. In one implementation, the table data structure includes a set of four linked tables, including table T₁, table T₂, table T₃, and table T₄. FIG. 5 shows a few representative entries in the tables, denoted in a high-level manner. In practice, the entries can take any form.

Assume that the hardware multiplexer 402 receives a packet 504 from an external or internal source entity 506. The packet includes a payload 508 and a header 510. The header specifies a particular VIP address (VIP₁) associated with a particular service to which the packet 504 is destined.

The mux-related processing module 414 first uses the VIP₁ address as an index to locate an entry (entry_{w}) in the first table T₁. That entry, in turn, points to another entry (entryₓ) in the second table T₂. That entry, in turn, points to a contiguous block 510 of entries in the third table T₃. The mux-related processing module 414 chooses one of the entries in the block 510 based on any selection logic. For example, the mux-related processing module 516 may hash one or more fields of the VIP address to produce a hash result; that hash result, in turn, falls into one of the bins associated with the entries in the block 510, thereby selecting the entry associated with that bin. The chosen entry (e.g., entry_{y3}) in the third table T₃ points to an entry (entry_{z}) in the fourth table T₄.

At this stage, the mux-related processing module 414 uses information imparted by the entry_{z} in the fourth table to generate a direct IP (DIP) address (DIP₁) associated with a particular DIP resource, where the DIP resource may correspond to a particular server which hosts the service associated with the VIP address. The mux-related processing module 414 then encapsulates the original packet 504 in a new packet 512. That new packet has a header 514 which specifies the particular DIP address (DIP₁). Finally, the mux-related processing module 414 forwards the new packet 512 to the destination DIP resource 516 associated with the DIP address (DIP₁).

In one implementation, the table T₁ may correspond to an L3 table, the table T₂ may correspond to a group table, the table T₃ may correspond to an ECMP table, and the table T₄ may correspond to a tunneling table. These are tables that a commodity hardware switch may natively provide, although they are not linked together in the manner specified in FIG. 5. Nor are they populated with the kind of mapping information specified above. More specifically, in some implementations, these tables include slots having entries that are used in performing native packet-forwarding functions within a network, as well as free (unused) slots. The load balancer system can link the tables in the specific manner set forth above, and can then load entries into unused slots to collectively provide an instance of mapping information for multiplexing purposes.

In other implementations, the load balancer may choose a different collection of tables to provide the table data structure, and/or use a different linking strategy to connect the tables together. The particular configuration illustrated in FIG. 5 is set forth by way of example, not limitation.

A.3. An Illustrative DIP Resource

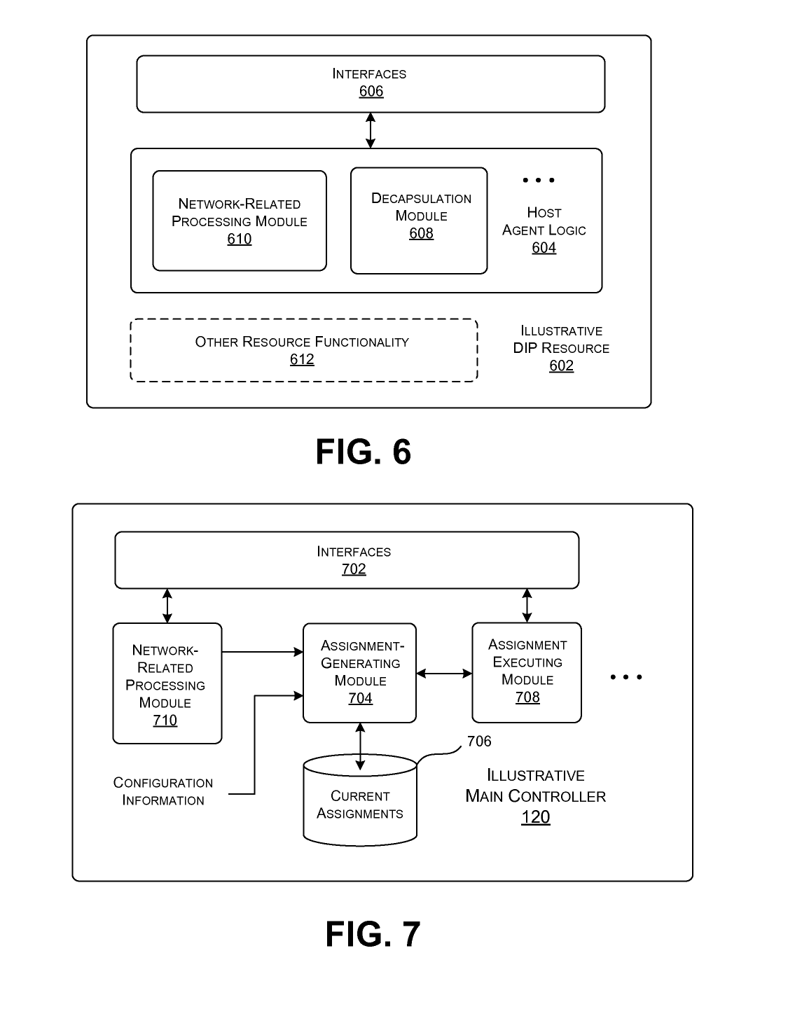

FIG. 6 shows one implementation of an illustrative DIP resource 602, which may correspond to functionality provided by a server. The server is associated with a particular DIP address, and is hence referred to as a particular DIP resource.

The DIP resource 602 includes host agent logic 604 and one or more interfaces 606 by which the host agent logic 604 may interact with other entities in the network. The host agent logic 604 includes a decapsulation module 608 for decapsulating the new packet sent by a hardware multiplexer, e.g., corresponding to the new packet 512 (of FIG. 5) generated by the hardware multiplexer 402 (of FIG. 4). Decapsulation entails removing the original packet 510 from the enclosing “envelope” of the new packet 512.

The host agent logic 604 may also include a network-related processing module 610. That component performs various network-related activities, such as compiling various traffic-related statistics regarding the operation of the DIP resource 602, and sending these statistics to the main controller 120.

The DIP resource 602 may also include other resource functionality 612. For example, the other resource functionality 612 may correspond to software which implements one or more services, etc.

A.4. The Main Controller

FIG. 7 shows the main controller 120, introduced in the context of FIG. 1. The main controller 120 includes a plurality of modules that perform different respective functions. Each module can be updated separately without affecting the other modules. The modules may communicate with each other using any protocol, such as by using RESTful APIs. The modules may interact with other entities of the load balancer (e.g., the hardware multiplexers, etc.) via one or more interfaces 702.

The main controller 120 includes an assignment generating module 704 for generating one or more instances of mapping information corresponding to one or more sets of VIP addresses. The assignment generating module 704 can use any algorithm to perform this function, such as a greedy assignment algorithm that assigns VIP addresses to one or more hardware multiplexers, one VIP address at a time, in a particular order. As a general strategy, the assignment generating module 704 attempts to choose one or more switches such that the processing and storage burden placed on the various resources in the network increases in an even manner as VIP addresses are allocated to one or more switches. Stated in the negative, the assignment generating module 704 seeks to avoid exceeding the capacity any resource in the network prior to utilizing the remaining capacity provided by other available resources in the network. In doing so, the assignment generating module 704 maximizes the amount of IP traffic that the load balancer system is able to accommodate. Section B describes one particular assignment algorithm that may be used by the assignment generating module 704 in greater detail. However, the assignment generating module 704 can also use other assignment algorithms, such as a random VIP-to-switch assignment algorithm, a bin packing algorithm, etc. In yet another case, an administrator of the data processing environment 104 can manually choose one or more hardware switches that will host a multiplexing function, and can then manually load mapping information onto the switch or switches.

A data store 706 stores information regarding the VIP-to-switch assignments that are currently in effect in the data processing environment 104. As will be described in Section B, the assignment generating module 704 can refer to the information stored in the data store 706 in deciding whether to migrate VIP addresses from their currently-assigned switches to newly-assigned switches. That is, the newly-assigned switches reflect the most recent assignment results generated by the assignment generating module 704; the currently-assigned switches reflect the immediately preceding assignment results generated by the assignment generating module 704. In one strategy, the assignment generating module 704 migrates an assignment from a currently-assigned switch to a newly-assigned switch only if doing so yields a significant advantage in terms of the utilization of resources in the network (to be described in greater detail below).

An assignment executing module 708 carries out the assignments provided by the assignment generating module 704. This operation may entail sending one or more instances of mapping information, provided by the assignment generating module 704, to one or more respective hardware switches. The assignment executing module 708 can interact with the hardware switches via the switches' interfaces, e.g., via RESTful APIs.

A network-related processing module 710 gathers information regarding the topology of the network which underlies the data processing environment 104, together with traffic information regarding traffic sent over the network. The network-related processing module 710 also monitors the status of the DIP resources and other entities in the data processing environment 104. The assignment generating module 704 can use at least some of the information provided by the network-related processing module 710 to trigger its assignment operation. The assignment generating module 704 can also use the information provided by the network-related processing module 710 to provide the values of various parameters used in the assignment operation.

A.5. A Second Implementation of the Load Balancer

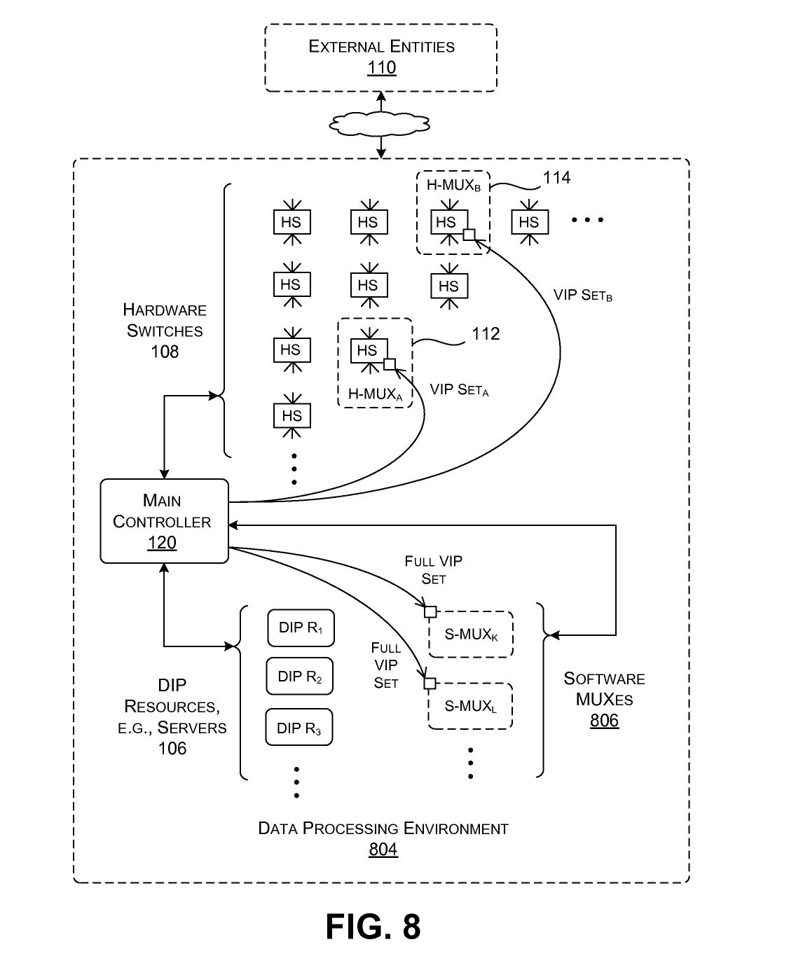

FIG. 8 shows another data processing environment 804 for implementing a load balancer system. The data processing environment 804 includes many of the same features as the data processing environment 104 of FIG. 1, including one or more hardware multiplexers (e.g., 112, 114), which may correspond to repurposed hardware switches, selected from among a collection of hardware switches 108. The data processing environment 804 also includes a main controller 120 for generating one or more instances of mapping information, corresponding to one or more respective VIP sets, and for loading the instance(s) of mapping information on the hardware multiplexer(s). Further, the data processing environment 804 includes a set of DIP resources 106 associated with respective DIP addresses.

As an additional feature, the data processing environment 804 includes one or more software multiplexers 806, such as S-Mux_{K} and S-Mux_{L}. Each software multiplexer performs a task that achieves the same outcome as a hardware multiplexer, described above. That is, each software multiplexer maps a VIP address to a DIP address, and encapsulates an original packet in a new packet addressed to the DIP address.

Each software multiplexer may interact with an instance of mapping information associated with the full set of VIP addresses, rather than just a portion of the VIP addresses. That is, both S-Mux_{K} and S-Mux_{L} may perform mapping for any VIP address handled by the data processing environment 804 as a whole, not just a VIP address in a mux-specific set. Hence, for the scenario in which the data processing environment 804 includes a single hardware multiplexer, both the software multiplexer and the hardware multiplexer handle the same set of VIP addresses, i.e., corresponding to the complete set hosted by the data processing environment 804. For the scenario in which the data processing environment 804 includes two or more hardware multiplexers (as shown in FIG. 1), the software multiplexer handles the complete of VIP addresses, while each hardware multiplexer, due to its limited memory capacity, may continue to handle just a portion of the complete set of VIP addresses. The software multiplexer can process the full set of VIP addresses, even for very large sets, because it is hosted by a computing device that has a memory capacity that is sufficient to store mapping information associated with the full set of VIP addresses.

More specifically, each software multiplexer may be hosted by a server or other type of software-driven computing device. In some cases, a server is dedicated to the role of providing one or more software multiplexers. In other cases, a server performs multiple functions, of which the multiplexing task is just one function. For example, a server may function as both a DIP resource (that provides some service associated with a VIP address), and a multiplexer. Each software multiplexer can announce its multiplexing capabilities (indicating that it can process all VIP addresses) using any routing protocol, such as BGP.

The main controller 120 can generate the full instance of mapping information, corresponding to the full set of VIP addresses. The main controller 120 can then forward that instance of mapping information to each computing device which hosts a software-multiplexing function. The load balancer system may store the full instance of mapping information on plural software multiplexers to spread the load imposed on the multiplexing functionality, and to increase availability of the multiplexing functionality in the event of failure of any individual software multiplexer.

The load balancer system as a whole, in the context of FIG. 8, corresponds to the main controller 120, the set of one or more switch-implemented hardware multiplexers, and the set of one or more software multiplexers 806.

In one implementation, the load balancer system is configured such that the hardware multiplexer(s) handles the great majority of the multiplexing tasks in the data processing environment 804. The load balancer system relies on a software multiplexer for a particular VIP address when: (a) the hardware multiplexer assigned to this VIP address is unavailable for any reason (instances of which will be cited in Subsection B.4); or (b) a hardware multiplexer was never assigned to this VIP address.

As to the latter case, the assignment generating module 704 (of the main controller 120) may order VIPs addresses based on the traffic associated with these addresses, and then sequentially assign VIP addresses to switches in the identified order, that is, one after the other, starting with the VIP that experiences the heaviest traffic and working down the list. The main controller 120 will continue assigning VIP addresses to hardware switches until the capacity limitations of at least one resource in the network is exceeded, at which point it will start allocating VIP addresses to the software multiplexers. For this reason, in some scenarios, the software multiplexers 806 may serve as the sole multiplexing agent for some VIP addresses which are associated with low traffic volume.

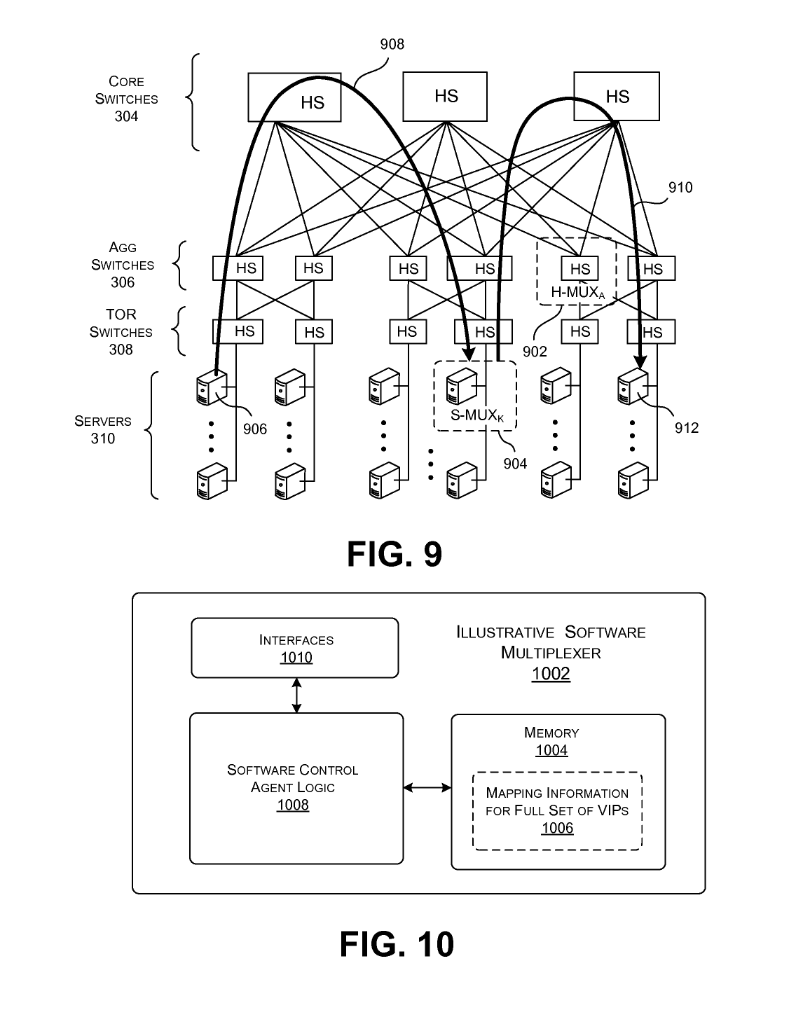

FIG. 9 shows one implementation of the data processing environment 804 of FIG. 8, e.g., corresponding to a data center or the like. The data processing environment of FIG. 9 includes the same types of switches and network topology explained above with reference to FIG. 3. That is, the data processing environment of FIG. 9 includes hierarchical arrangement of core switches 304, aggregation (agg) switches 306, TOR switches 308, etc. In the case of FIG. 9, at least one hardware multiplexer 902 (H-Mux_{A}) is hosted by an underlying hardware switch. At least one software multiplexer 904 (S-Mux_{K}) is handled by an underlying server.

Assume that a service that runs on the server 906 sends an inter-center packet to a particular VIP address. Assume that no hardware multiplexer advertises that it can handle this particular VIP address, e.g., because the hardware multiplexer that normally handles this particular VIP is unavailable for any reason, or because no hardware multiplexer has been assigned to handle this VIP address. But the software multiplexer 904 advertises that it handles all VIP addresses. Hence, in path 908, the routing functionality of the network will route the packet up through the switch hierarchy to a core switch, and then back down to the server hosting the software multiplexer 904. Assume that the software multiplexer 904 maps the VIP address to a particular DIP address, potentially selected from a set of possible DIP addresses. In a path 910, the routing functionality of the network will route the encapsulated packet produced by the software multiplexer 904 up through the hierarchy of switches to a core switch, and then back down to a server 912 that is associated with the DIP address.

Although not shown in FIG. 9, consider an alternative scenario in which both the hardware multiplexer 902 and the software multiplexer 904 handle the particular VIP address associated with the packet sent by the server 906. Both the hardware multiplexer 902 and the software multiplexer 904 will therefore advertise their availability to perform a multiplexing function for this particular VIP address. In this circumstance, the load balancer system can be configured to preferentially choose the hardware multiplexer 902 over the software multiplexer 904 to perform the multiplexing function. Different techniques can be used to achieve the above-stated outcome. In one such implementation, the hardware multiplexer 902 advertises its ability to handle a particular VIP address in a more specific manner compared to the software multiplexer 904, e.g., by announcing an address having a more detailed (longer) prefix compared to the address announced by the software multiplexer 904. Further assume that the path routing functionality uses the Longest Prefix Matching (LPM) technique to choose a next hop destination. The routing functionality will therefore automatically choose the hardware multiplexer 902 over the software multiplexer 904 because the hardware multiplexer 902 announces a version of the VIP address having a longer prefix compared to the software multiplexer 904. But when the hardware multiplexer 902 becomes unavailable for any reason, the address advertised by the software multiplexer 904 will be the only matching address, so the routing functionality will send the packet to the software multiplexer 904. This technique represents just one routing technique; still other techniques can be used to favor the hardware switches over the software-driven multiplexing functionality.

Assume instead that data processing environment offers plural redundant software multiplexers, and that no hardware multiplexer is currently available to handle a particular VIP address. As stated above, the load balancer system may use plural software multiplexers to spread out the multiplexing function, and to increase the availability of the multiplexing function in the event of failure of any software multiplexer. The load balancer system can use ECMP or the like to choose a particular software multiplexer among the set of possible software multiplexers.

FIG. 10 shows one implementation of a software multiplexer 1002, used by the load balancer system of FIG. 8. The software multiplexer 1002 can include any storage resource, such as memory 1004, for storing mapping information 1006 that corresponds to the full set of VIP addresses. The memory 1004 may correspond to the RAM memory provided by a server. The software multiplexer 1002 can also include control agent logic 1008 which performs similar tasks compared to the control agent logic 406 of FIG. 4 (provided by the hardware multiplexer 402). For instance, the control agent logic 1008 can include a mux-related processing module (not shown) that: (a) maps a particular VIP address to a particular DIP address; (b) encapsulates a the original packet (bearing the particular VIP address) in a new packet (bearing the particular DIP address); and then (c) sends the new packet to the DIP resource associated with the particular DIP address. But in this case, the control agent logic 1008 can directly map the VIP address to the DIP address without using the table structure described above with respect to FIG. 4.

The control agent logic 1008 can also include an update module (not shown) for loading the mapping information for the full set of VIP addresses into the memory 1004. The control agent logic 1008 can also include a network-related processing module (not shown) for handling network-related tasks, such as announcing its multiplexing capabilities to other entities in the network, sensing and reporting failures that affect the software multiplexer 904, and so on.

A.6. Other Features

This subsection describes additional features of the load balancer systems set forth above. These features are cited by way of example, not limitation. Other implementations of the load balancer systems can introduce additional features and variations, although not expressly set forth herein.

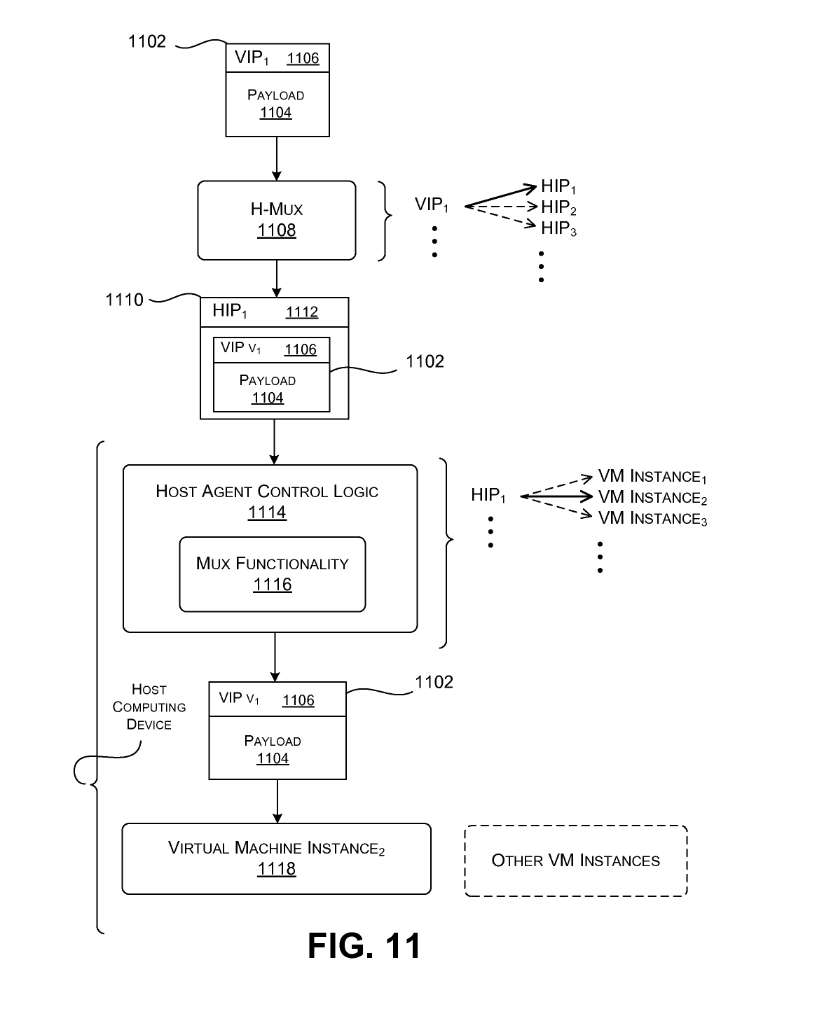

To begin with, FIG. 11 illustrates how the above-described load balancer systems can handle a situation in which services are provided by one or more virtual machine instances, hosted by one or more host computing devices.

More specifically, assume that an external or internal entity generates an original packet 1102 having a payload 1104 and a header 1106, where the header 1106 specifies a virtual IP address (VIP₁). Further assume that a hardware multiplexer 1108 advertises its ability to handle the particular VIP address VIP₁. Upon receipt of the original packet 1102, the hardware multiplexer 1108 maps the particular VIP address (VIP₁) to the direct IP address of a host computing device that, in turn, hosts the service to which the VIP₁ address corresponds. In this scenario, the DIP address of the host computing device is referred to as a host IP (HIP) address. In choosing the particular HIP address, the hardware multiplexer 1108 can potentially choose from among a set of possible HIP addresses, corresponding to plural host computing devices that host the service. The host multiplexer then encapsulates the original packet 1102 in a new packet 1110. The new packet 1110 has a header 1112 which contains the HIP address (e.g., HIP₁) of the target host computing device.

Host agent logic 1114 on the target host computing device receives the new packet 1110. It then decapsulates the packet 1110 and extracts the original packet 1102. The host agent logic 1114 may then uses multiplexing functionality 1116 to identify a virtual machine instance which provides the service to which the original packet 1102 is directed. In performing this task, the multiplexing functionality 1116 can potentially choose from among plural redundant virtual machine instances provided by the host computing device, which provide the same service, thereby spreading the load out among the plural virtual machine instances. Finally, the host agent logic 1114 forwards the original packet 1102 to the target virtual machine instance that has been chosen by the multiplexing functionality 1116.

In other words, as in previous cases, the direct IP (DIP) address generated by the hardware multiplexer 1108 identifies a DIP resource which hosts the target service; but in the case of FIG. 11, the DIP resource (corresponding to the host computing device) provides additional processing to forward the original packet 1102 to a particular virtual machine instance that is hosted by the DIP resource.

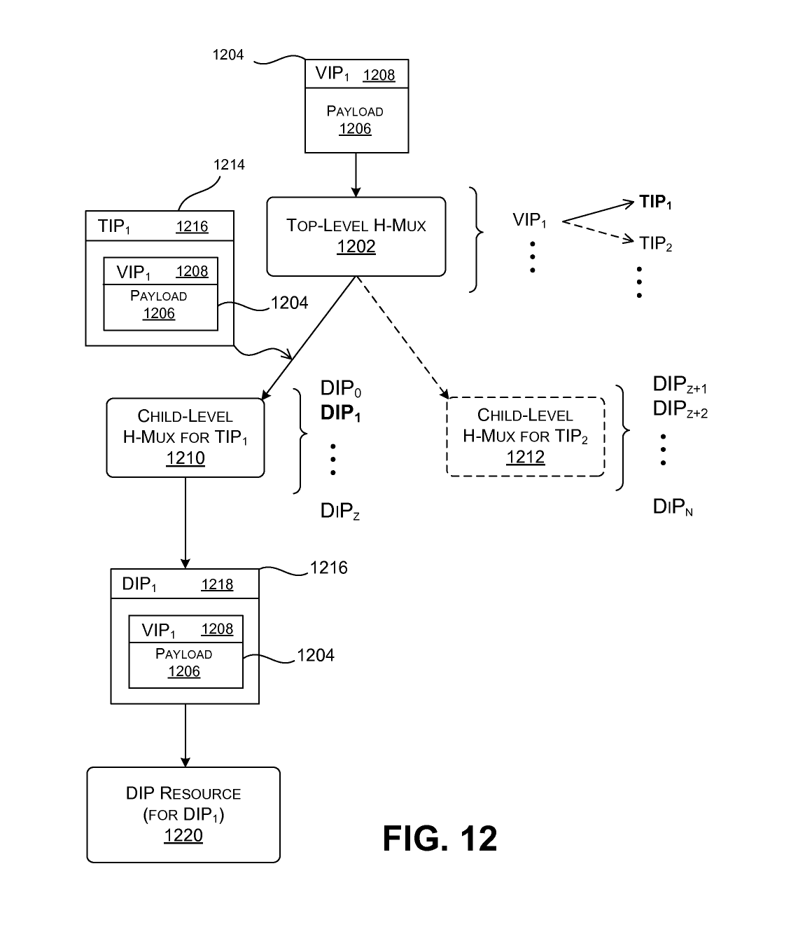

According to another feature, FIG. 12 illustrates how the above-described load balancer systems can handle a situation in which a single VIP address is associated with a large number of DIP addresses, corresponding, in turn, to respective DIP resources. Further assume that each hardware multiplexer has limited storage capacity, and therefore can only store entries for a certain number of DIPs (for example, a maximum of 512 DIPs, in one non-limiting implementation). In the context of FIG. 5, the limited storage capacity stems from the limited storage capacity of the T₃ and T₄ tables. If the number of DIP addresses associated with a single VIP resource exceeds the storage capacity of a hardware switch, then that hardware switch cannot handle the VIP address by itself. To address this situation, the load balancer systems described above can provide a hierarchy of hardware multiplexers which splits the set of DIP addresses among two or more child-level hardware multiplexers.

More specifically, assume that a top-level hardware multiplexer 1202 receives an original packet 1204 having a payload 1206 and a header 1208; the header 1208 bears a particular VIP address, VIP₁. That is, the top-level hardware multiplexer 1202 receives the packet 1204 because, as described before, it has advertised its ability to handle the particular VIP address in question.

The top-level hardware multiplexer 1202 then uses its multiplexing functionality to choose a transitory IP (TIP) address from among a plurality of TIP addresses. Each such TIP address corresponds to a particular child-level hardware multiplexer. In the case of FIG. 12, assume that the top-level hardware multiplexer 1202 chooses a TIP₁ address corresponding to a first child-level hardware multiplexer 1210, rather than a TIP₂ address corresponding to a second child-level hardware multiplexer 1212. The first child-level hardware multiplexer 1210 handles a first set of DIP addresses (DIP₀-DIP_{z}) associated with the VIP₁ address, while the second child-level hardware multiplexer 1212 handles a second set of DIP addresses (DIP_{z+1}-DIPₙ) associated with the VIP₁ address. Both child-level hardware multiplexers (1210, 1212) announce their association with their respective TIP addresses via any routing protocol, such as BGP. The top-level hardware multiplexer 1202 then encapsulates the original packet 1204 into a new packet 1214. The new packet 1214 has a header 1218 which bears the TIP address (TIP₁) of the first child-level hardware multiplexer 1210.

Upon receipt of the new packet 1214, the child-level hardware multiplexer 1210 decapsulates it and extracts the original packet 1204 and its VIP address (VIP₁). The child-level hardware multiplexer 1210 then uses its multiplexing functionality to map the VIP₁ address to one of its DIP addresses (e.g., one of the addresses in the set DIP₀ to DIP_{z}). Assume that it chooses DIP address DIP₁. The child-level hardware multiplexer 1210 then re-encapsulates the original packet 1204 in a new encapsulated packet 1216. The new encapsulated packet 1216 has a header 1218 which bears the address of DIP₁. The child-level hardware multiplexer 1210 then forwards the re-encapsulated packet 1216 to a DIP resource 1220 associated with DIP₁.

According to another feature (not shown), a virtual IP address may be accompanied by port information that identifies either an FTP port or an HTTP port (or some other port). A hardware (or software) multiplexer can treat IP addresses having different instances of port information as effectively different VIP addresses, and associate different sets of DIP addresses with these different VIP addresses. For example, a hardware multiplexer can associate a first set of DIP addresses for the FTP port of a particular VIP address, and another second of DIP addresses for the HTTP port of the particular VIP address. The hardware multiplexer can then detect the port information associated with an incoming VIP address and choose a DIP address from among an appropriate port-specific set of DIP addresses.

According to another feature (not shown), the data processing environments set forth above can handle outgoing connections in various ways. As explained above, for connections that are already established, the data processing environments can use the Direct Server Return (DSR) technique. This technique provides a way to send return packets to a source entity by bypassing the multiplexing functionality through which the inbound packet, sent by the source entity, was processed.

For a connection that has not already been established, the data processing environments can provide Source NAT (SNAT) support in the following manner. Assume that a particular DIP resource (e.g., a server) seeks to establish an outbound connection with a particular target entity, represented by a particular VIP address. The host agent logic 604 (of FIG. 6) of the DIP resource has access to the same hashing functions used by the hardware multiplexer(s). The DIP resource leverages the hashing functions to choose a port for an outgoing connection such that the hash of the VIP address will correctly map back to the DIP resource, that is, when a hardware multiplexer subsequently processes an inbound packet sent by the target entity. The host agent logic 604 performs this task for the first packet of the outbound connection; it does not need to repeat this determination for subsequent packets associated with the same connection.

B. Illustrative Processes

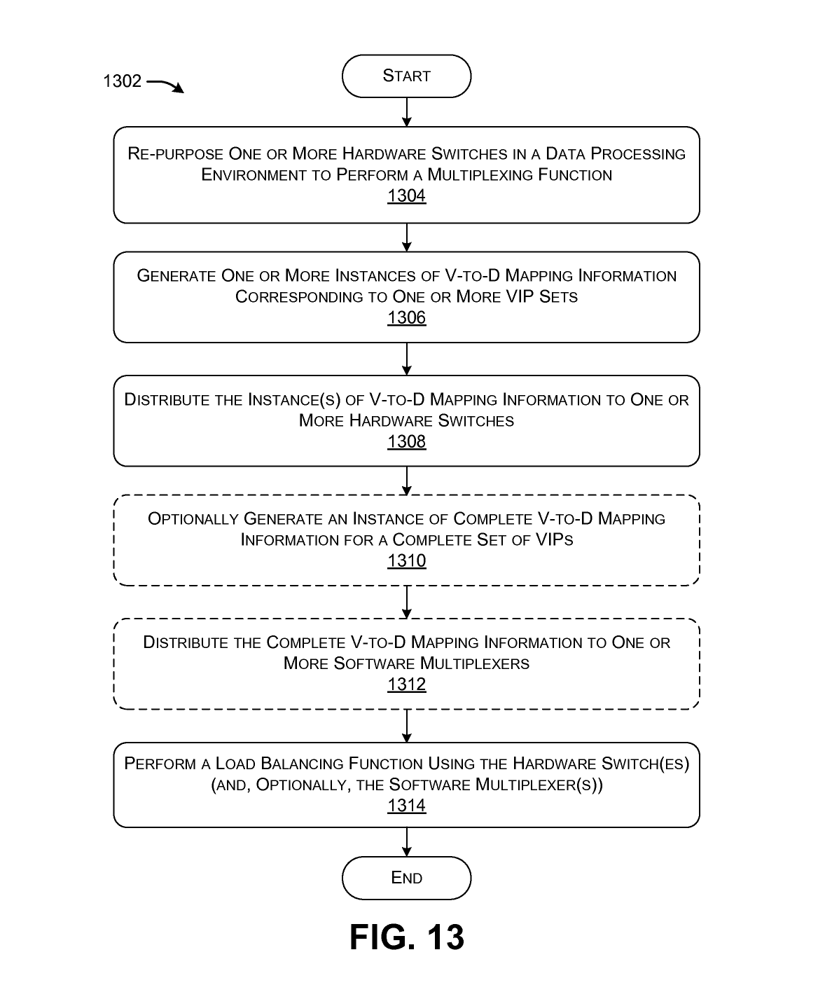

FIGS. 13-17 show procedures that explains one manner of operation of the load balancer systems of Section A. Since the principles underlying the operation of the load balancer systems have already been described in Section A, certain operations will be addressed in summary fashion in this section.

B.1. Overview

FIG. 13 is a procedure 1302 that provides an overview of one manner of operation of a load balancer system, such as the load balancer system described in the context of FIG. 1 or FIG. 8. In block 1304, the load balancer system repurposes one or more hardware switches in the data processing environment (e.g., the environment 104 of FIG. 1 or the environment 804 of FIG. 8) so that the switch(es) perform multiplexing functions. In block 1306, the main controller 120 generates one or more instances of virtual-address-to-direct-address (V-to-D) mapping information, corresponding to one or more VIP sets. An instance of V-to-D mapping information may correspond to a full set of VIP addresses (in the case that one hardware switch is used) or a portion of the full set of VIP addresses (in the case that plural hardware switches are used). In block 1308, the main controller 1308 distributes the one or more instances of V-to-D mapping information to the one or more hardware switches, thereby configuring these switches as hardware multiplexers. In block 1310, for the embodiment of FIG. 8, the main controller 120 can also optionally generate an instance of V-to-D mapping information which corresponds to a full (master) set of VIP addresses. In block 1312, the main controller 120 can distribute the resultant instance of V-to-D mapping information to one or more software multiplexers. In block 1314, the load balancer system performs a load balancing operation using the hardware multiplexer(s) and software multiplexer(s) (if provided).

B.2. A Process for Processing a VIP Using a Hardware Switch

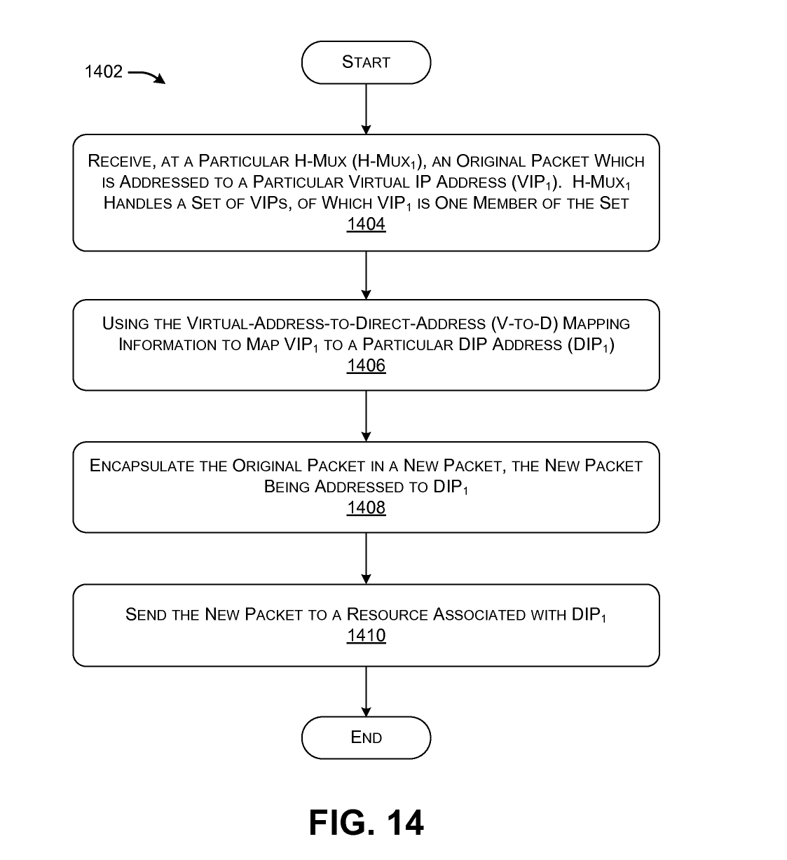

FIG. 14 is a procedure 1402 that explains one manner of operation of an individual hardware switch, constituting a hardware multiplexer. In block 1404, the hardware multiplexer receives an original packet having a header which is directed to particular virtual IP address (VIP₁). The hardware multiplexer receives this particular VIP address because it has announced its ability to handle this VIP address, e.g., using BGP. In block 1406, the hardware multiplexer uses its local instance of V-to-D mapping information, provided by the table data structure 502 of FIG. 5, to map the VIP₁ address to a particular DIP address (DIP₁), potentially selected from a set of DIP addresses associated with VIP₁. In block 1408, the hardware multiplexer encapsulates the original packet into a new packet, having a header which specifies the DIP₁ address. In block 1410, the hardware multiplexer forwards the new packet to the DIP resource associated with the DIP₁ address.

B.3. A Process for Assigning VIPs to MUXes

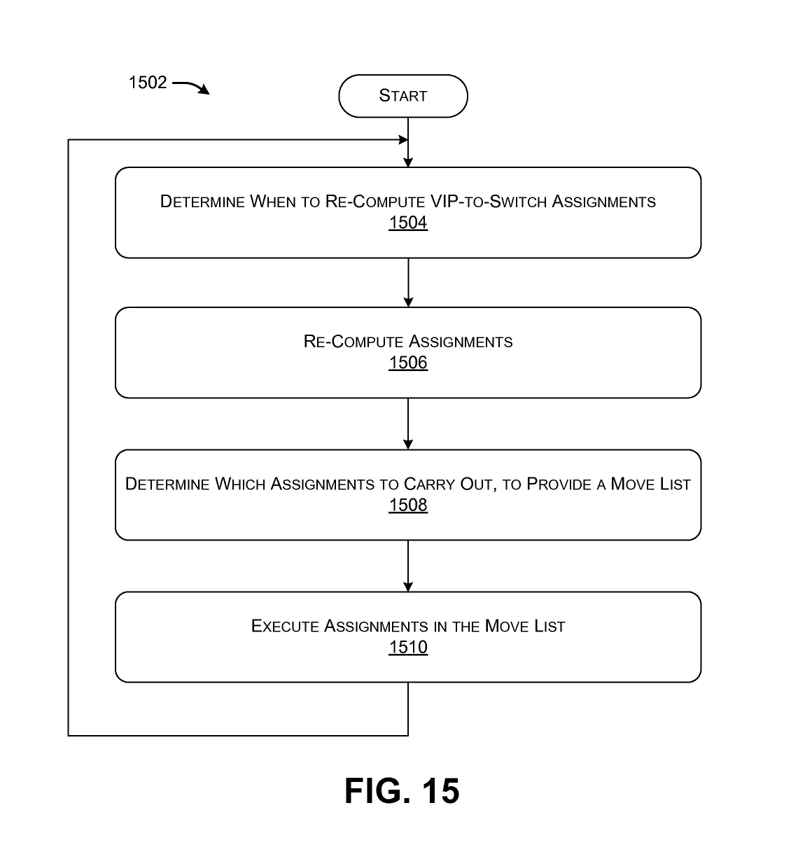

FIG. 15 is a procedure 1502 which represents an overview of an assignment operation performed by the assignment generating module 704 of the main controller 120, introduced in the context of FIG. 7. To simplify and facilitate explanation, this subsection will be framed in an illustrative context in which the assignment generating module 704 potentially assigns different VIP sets to two or more hardware switches, each such set corresponding to a portion of a master set of VIP addresses. But as explained in Section A, in another scenario, the assignment generating module 704 (or a human administrator) can assign the master set of VIP addresses to a single hardware switch, or can assign two or more redundant copies of the master set to two or more hardware switches.

In block 1504, the assignment generating module 704 determines whether it is time to generate a new set of assignments, e.g., in which VIP addresses are assigned to selected hardware multiplexers (and software multiplexers, if provided). For example, the assignment generating module 704 can perform the assignment operation on a periodic basis, e.g., every 10 minutes. In addition, or alternatively, the assignment generating module 704 can perform the assignment operation when a change occurs in the network associated with the data processing environment, such as the failure or removal of any component, the introduction of any new component, a change in workload experienced by any component, a change in performance experienced by any component, and so on.

In block 1506, once triggered, the assignment generating module 704 re-computes the assignments. In block 1508, the assignment generating module 704 determines which assignments, computed in block 1506, are significant enough to carry out, to provide a move list. In block 1510, the assignment executing module 708 executes the assignments in the move list.

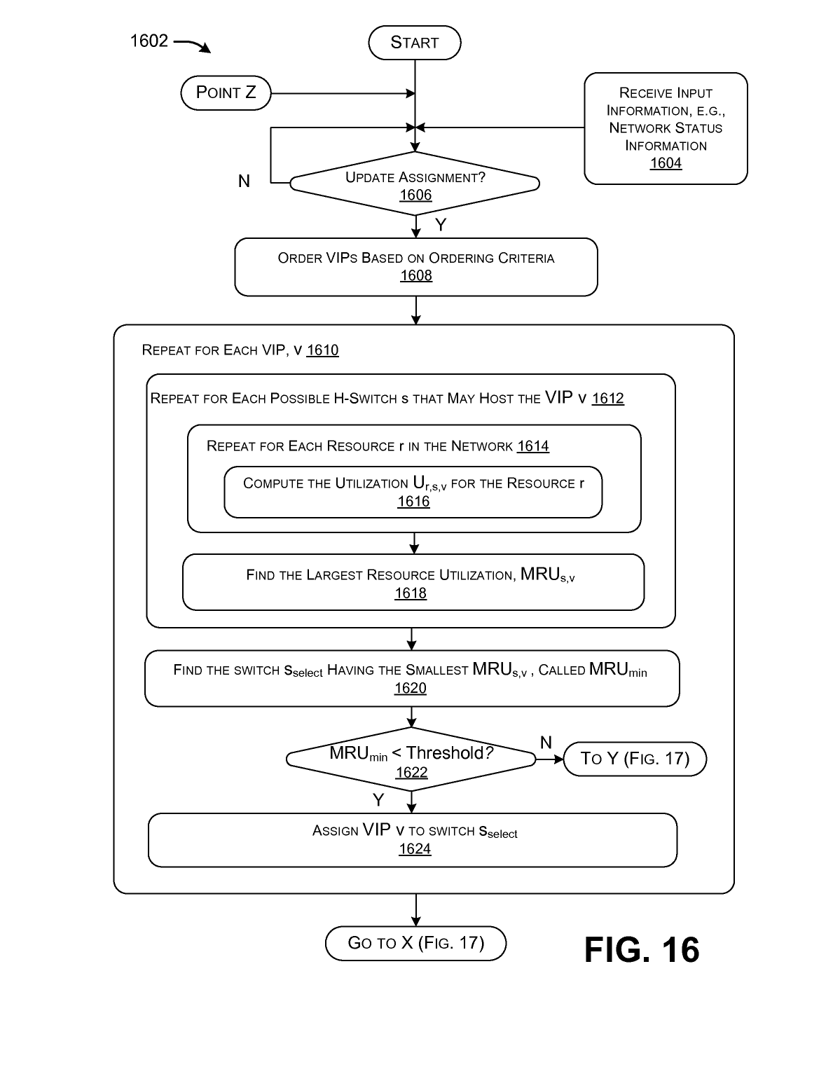

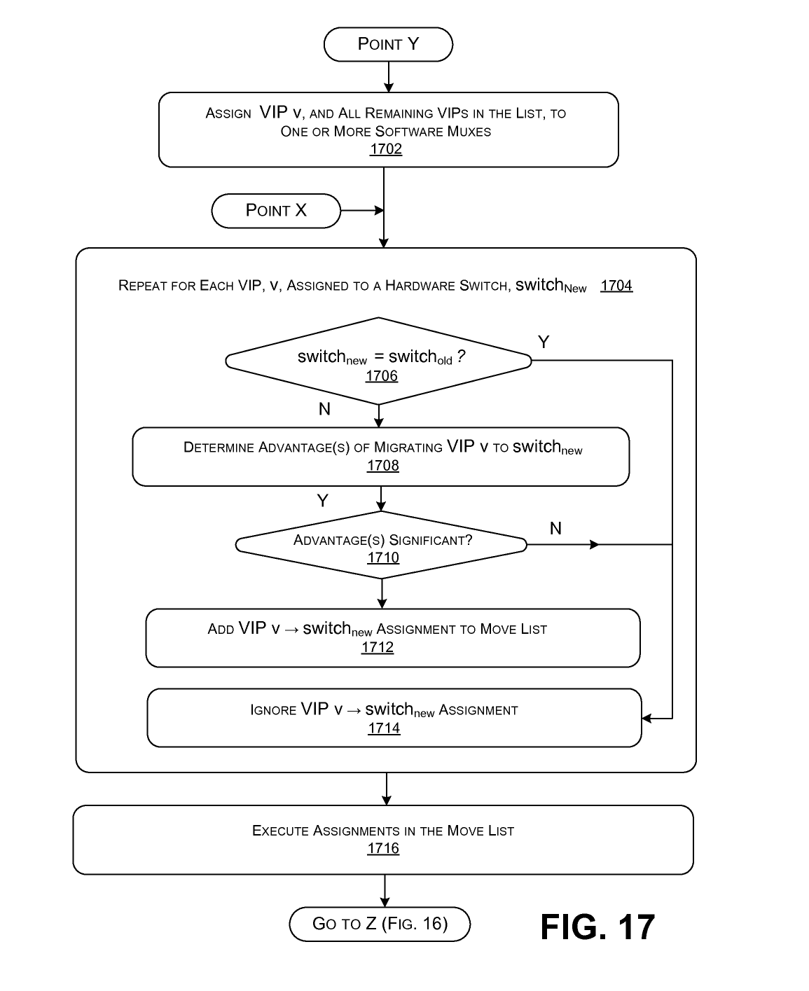

FIGS. 16 and 17 together show a procedure 1602 that represents one technique for performing the assignment operations of FIG. 15, according to one non-limiting implementation. Starting with FIG. 16, in block 1604, the assignment generating module 704 receives input information which serves to set up the assignment operation. The input information may describe a list of VIPs to be assigned, the DIPs for each individual VIP, and the traffic volume for each VIP. The per-VIP traffic volume can be provided by various monitoring agents which monitor traffic within the network, such as the network-related module 610 associated with each DIP resource, etc. The input information also describes the current topology of the network, which includes a set of switches (S), and a set of links (E) which connect the switches together, and which connect the switches the DIP resources.

Each individual switch and link constitutes a resource having a prescribed capacity. The capacity of a switch corresponds to the amount of memory which it can devote to storing V-to-D mapping information—more specifically, corresponding to the number of slots in the tables which it can devote to storing the V-to-D mapping information. The capacity of a link may be set as some fraction of its bandwidth, such as 80% of its bandwidth. Setting the capacity of a link in this manner accommodates transient congestion that may occur during VIP migration and network failures.

In block 1606, the assignment generating module 704 determines whether it is time to update the assignment of VIPs to switches. As already described in the context of FIG. 15, the assignment generating module 704 can update the assignments on a periodic basis and/or in response to certain changes in the network.

Upon the commencement of an assignment run, in block 1608, the assignment generating module 704 orders the VIPs to be assigned based on one or more ordering factors. For example, the assignment generating module 704 can order the VIPs in descending order based on the traffic volume associated with the VIPs. As such, the assignment generating module 704 will first attempt to assign the VIP that is associated with the heaviest traffic to a hardware switch within the network. Alternatively, or in addition, the assignment generating module 704 can preferentially position certain VIPs in the order of VIPs based on the latency-sensitivity of their associated services. That is, the assignment generating module 704 may give preference to VIPs of services that require higher levels of latency, compared to other services. In some implementations, an administrator of a service may also pay a fee for premium latency-related performance by the load balancer system; this outcome may be achieved, in part, by preferentially positioning the VIP of such a service in the list of VIPs to be assigned.

As indicated in outer-enclosing block 1610, the assignment generating module 704 performs a series of operations for each VIP address under consideration, processing each VIP addresses in the order established in block 1608. As indicated in nested block 1612, the assignment generating module 704 examines the effects of assigning a particular VIP v, currently under consideration, to each possible hardware switch s within the data processing environment. And in nested block 1614, the assignment generating module 704 considers the effect that the assignment of VIP v to switch s will have on each resource r in the data processing environment. The resources include each other switch in the network and each link the network.

More specifically, in block 1616, the assignment generating module computes the utilization U_{r,s,v} that will be imposed on resource r if the VIP v under consideration is assigned to a particular switch s. More specifically, the added (delta) utilization L_{r,s,v} on a switch resource, caused by the assignment, can be expressed by dividing the number of DIPs associated with the VIP v over the memory capacity of the switch. The added (delta) utilization L_{r,s,v} on a link resource, caused by the assignment, can be expressed by dividing the VIP's traffic over the link in question by the capacity of the link. The full utilization of a resource can be found by adding the added (delta) utilization to its existing utilization, e.g., resulting from the assignment of previous VIPs (if any) to the resource, if any. That is, U_{r,s,v}=U_{r,v-1}+L_{r,s,v}. In block 1618, after considering the utilization scores for each resource associated with a particular VIP-to-switch assignment, the assignment generating module 704 determines the utilization score having the maximum utilization, which is referred to as MRU_{s,v}. In less formal terms, the maximum utilization corresponds to the resource (switch or link) that is closest to reaching its maximum capacity. Once a resource reaches it maximum capacity, the load balancer system cannot effectively add further VIPs to the particular switch under consideration.

In block 1620, after considering the effects of placing the VIP v on all possible switches, the assignment generating module 704 picks the switch having the smallest MRU (i.e., MRUₘᵢₙ); that switch is referred to in FIG. 16 as s_{select}. In block 1622, the assignment generating module 704 determines whether MRUₘᵢₙ is less than a prescribed capacity threshold, such as 100%. If not, this means that no switch can accept the VIP address v without exceeding the maximum capacity of some resource. If this is the case, the processing flow advances to block 1702 of FIG. 17. In this operation, the assignment generating module 704 assigns the VIP v, and all subsequent VIPs (VIPᵥ₊₁, VIPᵥ₊₂ . . . VIPₙ) in the ordered list of VIPs, to the software multiplexers. On the other hand, if the threshold is not exceeded, then, in block 1624 (of FIG. 16), the assignment generating module 704 assigns the VIP v to the switch s_{select}.

The remainder of the assignment algorithm set forth in FIG. 17 determines when and how to carry out VIP-to-switch assignments. As per block 1704, this operation is performed with respect to each VIP v that has been assigned to a particular hardware switch, switch_{new}, based on the outcome of the assignment operations set forth above. The VIP v may be currently assigned to a switch, switch_{old}, e.g., as a result of a previous iteration of the assignment algorithm.

More specifically, in block 1706, the assignment generating module 704 determines whether the switch_{new} assignment for the VIP v is the same as the current, switch_{old}, assignment for the VIP v. If they differ, then, in block 1708, the assignment generating module 704 determines the advantage of migrating the VIP v from switch_{old} to switch_{new}. “Advantage” can be assessed based on any metric(s), such as by subtracting the MRU associated with the new assignment from the MRU associated with the old assignment, to provide an advantage score. In block 1710, the assignment generating module 704 determines whether the advantage score determined in block 1708 is significant, e.g., by comparing the advantage score with a prescribed threshold. In block 1712, if the advantage score is deemed significant, then the assignment generating module 704 can add the new switch assignment to a move list. In block 1714, if the advantage is not deemed significant, or if the switch assignment has not even changed, then the assignment generating module 704 can ignore the new switch assignment. The advantage-calculating routine described above is useful to reduce the disturbance to the network caused by VIP reassignment, and thereby to reduce any negative performance impact caused by the VIP reassignment.

In block 1716, the assignment executing module 708 executes the assignments in the move list. More specifically, the assignment executing module 708 can perform migration in different ways. In one technique, the assignment executing module 708 operates by first withdrawing the VIPs that need to be moved from their currently assigned switches, e.g., by removing the entries associated with these VIPs from the table structures of the switches. The switches will then announce that they no longer host the VIPs in question, e.g., using BGP. As a result, the traffic directed to these VIPs will be directed to one or more software multiplexers, which continue to host all VIPs. The assignment executing module 708 can then load the VIPs in the move list on the new switches, at which point these new switches will advertise the new VIP assignments. The load balancer system will then commence to preferentially direct traffic to the hardware switches which host the VIPs that have been moved, rather than the software multiplexers.

The assignment algorithm imposes a processing burden that is proportional to the product of the number of VIP addresses to be assigned, the number of switches in the network, and the number of links in the network. In certain cases, the topology of the network simplifies the analysis, insofar as conclusions can be reached for different parts of the network in independent fashion.

B.4. Processes for Handling Particular Events

The remaining subsection describes one manner in which a load balancer system may respond to various events. These techniques are set forth by way of illustration, not limitation; other implementations can use other techniques to handle the events.

Failure of a Hardware Multiplexer.

The failure of a switched-based hardware multiplexer may be detected by neighboring switches that are coupled to the hardware multiplexer. To address this event, the load balancer system removes routing entries in other switches that make reference to VIPs assigned to the failed hardware multiplexer, e.g., by a BGP withdrawal technique or the like. At this juncture, the load balancer system forwards packets that are addressed to the withdrawn VIPs to a software multiplexer, which acts as a backup multiplexing service for all VIPs. Note that the software multiplexer uses the same hashing functions as the hardware multiplexer(s) to select DIP addresses, given specified VIP addresses. As such, existing connections will not break. However, these existing connections may experience packet drops and/or packet reordering until routing convergence is achieved.

Failure of a Software Multiplexer.

Switches can detect the failure of a software multiplexer using BGP. A failed software multiplexer does not have a significant impact on the processing of VIPs that are assigned to the hardware multiplexer(s), since the software multiplexer operates mainly as a backup for the hardware multiplexer(s). For VIPs that are assigned to only software multiplexers, the load balancer system can use ECMP to direct the VIPs to other non-failed software multiplexers. Existing connections will not break. However, these existing connections may experience packet drops and/or packet reordering until routing convergence is achieved.

Failure of a Link.

In those cases in which a link failure isolates a switch, the switch in question is considered to have failed. The failure of a hardware switch has the same failure profile set forth above. In other cases, the failure of link may cause VIP traffic to be rerouted, but it will not otherwise impact the availability of the multiplexing functionality provided by the load balancer system.

Failure or Removal of a DIP Resource.

The failure of a DIP resource (e.g., a server) may be detected by various entities in the network, such as the main controller 120. In response to this event, the load balancer system removes the entries associated with the associated DIP address in any multiplexer in which it appears. This DIP address may correspond to a member of a set of DIP addresses associated with a particular VIP address. The other DIP addresses in the set are not affected by the removal of a DIP address because each hardware multiplexer uses resilient hashing. In resilient hashing, traffic directed to a removed DIP address is spread among the remaining DIP addresses in the set, without otherwise affecting the other DIP addresses. However, connections to the failed DIP address are terminated.

Addition of a New VIP Address.

The load balancer system first adds a new VIP address to the software multiplexers. The assignment algorithm, when it runs next, may then assign the new VIP address to one or more hardware multiplexers. In this sense, the software multiplexer operates as a staging buffer for new VIP addresses.

Removal of a VIP Address.

The load balancer system handles the removal of a VIP address by removing entries associated with this address from all hardware multiplexers and software multiplexers in which it appears. The load balancer system can use BGP withdraw messages to remove references to the removed VIP address in all other switches.

Addition of a DIP Address to a Set of DIP Addresses Associated with a VIP Address.

The load balancer system handles this event by first removing the VIP address from all hardware multiplexers in which it appears. The load balancer system will thereafter route traffic directed to the VIP address to the software multiplexers, which acts as a backup for all VIPs. The load balancer system can then add the new DIP address to the set of DIP addresses associated with the VIP address. The load balancer system can then rely on the assignment algorithm to move the VIP address back to one or more hardware multiplexers, along with its updated DIP set. This protocol prevents existing connections from being remapped. If the VIP address is assigned to only the software multiplexers, then the new DIP can be added to the family of DIP addresses without disturbing existing connections, since the software multiplexers maintain detailed state information for existing connections.

C. Representative Computing Functionality

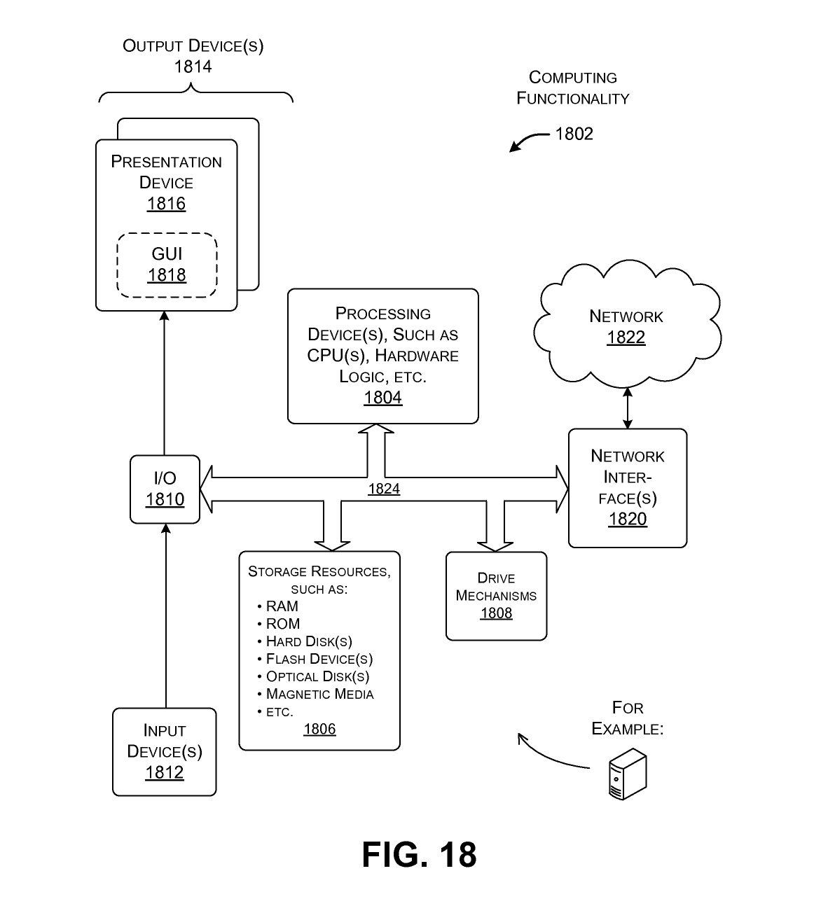

FIG. 18 shows computing functionality 1802 that can be used to implement various parts of the load balancer systems described in Section A. For example, with reference to FIGS. 1 and 8, the type of computing functionality 1802 shown in FIG. 18 can be used to implement a server, which, in turn, can be used to implement any of: the main controller 120, any of the DIP resources 106, and/or any of the software multiplexers 806. (Illustrative implementations of the hardware switches were already discussed in the context of the explanation of FIG. 4.)

The computing functionality 1802 can include one or more processing devices 1804, such as one or more central processing units (CPUs), and/or one or more graphical processing units (GPUs), and so on. The computing functionality 1802 can also include any storage resources 1806 for storing any kind of information, such as code, settings, data, etc. Without limitation, for instance, the storage resources 1806 may include any of: RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removal component of the computing functionality 1802. The computing functionality 1802 may perform any of the functions described above when the processing devices 1804 carry out instructions stored in any storage resource or combination of storage resources.

As to terminology, any of the storage resources 1806, or any combination of the storage resources 1806, may be regarded as a computer readable medium. In many cases, a computer readable medium represents some form of physical and tangible entity. The term computer readable medium also encompasses propagated signals, e.g., transmitted or received via physical conduit and/or air or other wireless medium, etc. However, the specific terms “computer readable storage medium” and “computer readable medium device” expressly exclude propagated signals per se, while including all other forms of computer readable media.

The computing functionality 1802 also includes one or more drive mechanisms 1808 for interacting with any storage resource, such as a hard disk drive mechanism, an optical disk drive mechanism, and so on.

The computing functionality 1802 also includes an input/output module 1810 for receiving various inputs (via input devices 1812), and for providing various outputs (via output devices 1814). Illustrative types of input devices include key entry devices, mouse entry devices, touchscreen entry devices, voice recognition entry devices, and so on. One particular output mechanism may include a presentation device 1816 and an associated graphical user interface (GUI) 1818. The computing functionality 1802 can also include one or more network interfaces 1820 for exchanging data with other devices via a network 1822. One or more communication buses 1824 communicatively couple the above-described components together.

The network 1822 can be implemented in any manner, e.g., by a local area network, a wide area network (e.g., the Internet), point-to-point connections, etc., or any combination thereof. The network 1822 can include any combination of hardwired links, wireless links, routers, gateway functionality, name servers, etc., governed by any protocol or combination of protocols.

Alternatively, or in addition, any of the functions described in this section can be performed, at least in part, by one or more hardware logic components. For example, without limitation, the computing functionality 1802 can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc.

In closing, the description may have described various concepts in the context of illustrative challenges or problems. This manner of explanation does not constitute a representation that others have appreciated and/or articulated the challenges or problems in the manner specified herein. Further, the claimed subject matter is not limited to implementations that solve any or all of the noted challenges/problems.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A load balancer system for distributing traffic load among resources within a data processing environment, comprising:
one or more hardware switches, each hardware switch including:
memory for storing a table data structure, the table data structure providing virtual-address-to-direct-address (V-to-D) mapping information that is associated with a set of virtual addresses;
control agent logic configured to perform a multiplexing function by:
receiving an original packet that includes a particular virtual address and a data payload, the particular virtual address corresponding to a member of the set of virtual addresses assigned to the hardware switch;
using the V-to-D mapping information to map the particular virtual address to a particular direct address;
encapsulating the original packet in a new packet, the new packet being given the particular direct address; and
forwarding the new packet to a resource associated with the particular direct address.

2. The load balancer system of claim 1, wherein at least one hardware switch is implemented as an Application Specific Integrated Circuit (ASIC).

3. The load balancer system of claim 1, wherein at least one hardware switch is configured to serve a packet-forwarding function that is independent of the multiplexing function.

4. The load balancer system of claim 1, wherein at least one hardware switch is selected from among: a set of core switches in a data center; a set of aggregation switches in a data center; and/or a set of top-of-rack (TOR) switches in a data center.

5. The load balancer system of claim 1, wherein at least one hardware switch is associated with a server in a data center.

6. The load balancer system of claim 1, wherein the particular direct address corresponds to a member of a set of direct addresses associated with the particular virtual address, and wherein the control agent logic is configured to use a selection technique to choose the particular direct address from the set of direct addresses.

7. The load balancer system of claim 6, wherein the selection technique is a hashing technique that comprises forming a hash of information extracted from a packet header of the original packet.

8. The load balancer system of claim 1, wherein said one or more hardware switches corresponds to a single hardware switch, and wherein the single hardware switch operates based on V-to-D mapping information associated with a full set of virtual addresses that is handled by the data processing environment.

9. The load balancer system of claim 1, wherein said one or more hardware switches corresponds to two or more hardware switches, and wherein each such hardware switch operates based on V-to-D mapping information associated with a portion of a full set of virtual addresses that is handled by the data processing environment.

10. The load balancer system of claim 1, further comprising a main controller configured to:
determine one or more sets of virtual addresses;
prepare one or more instances of V-to-D mapping information associated with said one or more sets of virtual addresses; and
load said one or more instances of V-to-D mapping information on said respective one or more hardware switches.

11. The load balancer system of claim 1, wherein the load balancer system includes one or more software multiplexers, each for performing a multiplexing function with respect to a complete set of virtual addresses that is handled by the data processing environment.

12. The load balancer system of claim 11, wherein each software multiplexer is implemented as a software program running on a computing device within the data processing environment.

13. The load balancer system of claim 1,
wherein the resource associated with the particular direct address is a computing device that hosts a set of one or more virtual machine instances; and
wherein the resource includes host agent control logic configured to:
de-encapsulate the new packet;
identify a selected virtual machine instance from the set of virtual machine instances; and
forward the original packet to the selected virtual machine instance, based on the particular virtual address associated with the original packet.

14. The load balancer system of claim 1, further comprising:
at least one top-level hardware switch for mapping a particular virtual address to a particular transitory address, selected from a set of possible transitory addresses; and
a plurality of child-level hardware switches that are coupled to the top-level hardware switch,
each child-level hardware switch being associated with one transitory address in the set of possible transitory address, and
each child-level hardware switch handling a different portion of a complete set of DIP addresses that are associated with the particular VIP address.

15. A data processing environment, comprising:
a plurality of resources for executing one or more services;
a load balancer system for distributing traffic load among the resources within the data processing environment, the load balancer system comprising:
one or more hardware multiplexers having respective memories and instances of control agent logic,
each memory storing an instance of virtual-address-to-direct-address (V-to-D) mapping information,
each instance of the control agent logic being configured to perform a multiplexing function by using an associated instance of V-to-D mapping information to map a particular virtual address, associated with a received original packet, to a particular direct address; and
a main controller configured to generate one or more instances of V-to-D mapping information, and to distribute said one or more instances of V-to-D mapping information to said one or more hardware multiplexers.

16. The data processing environment of claim 15,
wherein at least one hardware multiplexer is implemented by a hardware switch in the data processing environment.
and wherein the hardware switch is configured to also serve a packet-forwarding function that is independent of the multiplexing function performed by the control agent logic of the hardware switch.

17. The data processing environment of claim 16, wherein the hardware switch is configured to provide a table data structure made up of one or more tables, the table data structure storing an instance of V-to-D mapping information.

18. A method for performing load balancing in a data processing environment, comprising:
re-purposing one or more existing hardware switches in the data processing environment to perform a multiplexing function, in addition to a native packet-forwarding function;
generating one or more instances of virtual-address-to-direct-address (V-to-D), each instance corresponding to a set of virtual addresses;
distributing said one or more instances of V-to-D mapping information to said one or more hardware switches, for storage in respective memories of said one or more hardware switches; and
using said one or more hardware switches to perform a load balancing function in the data processing environment, in which traffic associated with virtual addresses is distributed to resources associated with direct addresses in a balanced manner.

19. The method of claim 18, further comprising re-performing said generating on an event-driven and/or periodic basis.

20. The method of claim 18, further comprising:
generating a complete instance of V-to-D mapping information which corresponds to a complete set of virtual addresses that is handled by the data processing environment; and
distributing the complete instance of V-to-D mapping information to one or more software multiplexers implemented by respective computing devices.
